(19) United States
(12) Patent Application Publication
(10) Pub. No.: US 2021/0279618 A1
(43) Pub. Date: Sep. 9, 2021

(54) SYSTEM AND METHOD FOR BUILDING AND USING LEARNING MACHINES TO UNDERSTAND AND EXPLAIN LEARNING MACHINES

(71) Applicant: DARWINAI CORPORATION, Waterloo (CA)

(72) Inventors: Xiao Yu Wang, Waterloo (CA); Alexander Sheung Lai Wong, Waterloo (CA)

(21) Appl. No.: 17/187,743

(22) Filed: Feb. 27, 2021

Related U.S. Application Data
(63) Continuation of application No. PCT/CA2019/050377, filed on Mar. 27, 2019.
(60) Provisional application No. 62/724,566, filed on Aug. 29, 2018.

(51) Int. Cl. G06N 5/04; G06N 20/00; G06K 9/62

(52) U.S. Cl. CPC G06N 5/045; G06K 9/6267; G06N 20/00

(57) ABSTRACT

Systems, devices and methods are provided for building and using learning machines to understand and explain learning machines. The present system comprises a reference learning machine and an explainer learning machine being built for explaining and understanding the reference learning machine. A set of input signals is fed through the reference learning machine and the outputs at the different components of the learning machine for each given input signal are recorded. The recorded outputs at the different components of the learning machine for each given input signal, along with the corresponding expected output of the learning machine for each given input signal, are then used to update the parameters of the explainer learning machine. After the parameter update process, the explainer learning machine can then be queried for quantitative insights about the reference learning machine.

### CROSS-REFERENCE TO RELATED APPLICATIONS

The present application is a continuation of International Application No. PCT/CA2019/050377, filed Mar. 27, 2019, which claims priority to U.S. Provisional Application Ser. No. 62/724,566, filed Aug. 29, 2018, the disclosures of both of which are incorporated herein in their entireties.

### FIELD OF THE INVENTION

The present disclosure relates generally to the field of machine learning, and in one aspect, but not by way of limitation, to systems and methods for building and using learning machines to understand and explain learning machines.

### BACKGROUND

Learning machines are machines that can learn from data and perform tasks. Examples of learning machines include, but are not limited to, kernel machines, decision trees, decision forests, random forests, sum-product networks, Bayesian networks, Boltzmann machines, and neural networks. For example, graph-based learning machines such as neural networks, graph networks, sum-product networks, Boltzmann machines, and Bayesian networks typically consist of a group of nodes and interconnects that are able to process samples of data to generate an output for a given input, and learn from observations of the data samples to adapt or change. Such learning systems may be embodied in software executable by a processor or in hardware in the form of an integrated circuit chip or on a computer, or in a combination thereof.

One of the biggest challenges in using certain types of learning machines such as certain types of graph-based learning machines (e.g., neural networks, graph networks, Boltzmann machines, and sum-product networks) is that it is often extremely difficult to understand and explain the inner workings of such learning machines, which is commonly referred to as the ‘black box’ problem. The limitations in understanding and explaining such learning machines make it hard to trust the decisions made by such learning machines, make it hard to fix such learning machines when they generate incorrect outputs, make it hard to identify biases in the outputs generated by such learning machines, and make it difficult to design better learning machines.

A need therefore exists to develop systems and methods for building and using learning machines that can understand and explain other learning machines to address the above mentioned and other limitations and challenges.

### SUMMARY

The present disclosure provides practical applications and technical improvements to the field of machine learning, and more specifically to systems and methods for building and using learning machines to understand and explain learning machines.

In general, the present system may comprise a reference learning machine and an explainer learning machine being built for explaining and understanding the reference learning machine. The reference learning machines in the system may include but are not limited to sum-product networks, Bayesian networks, Boltzmann machines, and neural networks. The input signals can be grouped into one or more discrete states based on the outputs of the reference learning machine for a given input signal.

In some embodiments, the system feeds a set of test input signals through the reference learning machine and the outputs at the different components of the reference learning machine for each given test input signal are recorded. The recorded outputs at the different components of the reference learning machine for each given test input signal, along with the corresponding expected outputs of the reference learning machine for each given test input signal, are then used to update the parameters of the explainer learning machine. After the parameter update process, the explainer learning machine can then be queried for quantitative insights about the reference learning machine that include, but not limited to: the degree of importance of each component of the reference learning machine to the reference learning machine's generation of outputs for input signals associated with the possible states, the set of components in the reference learning machine that have high degrees of importance to the reference learning machine's generation of outputs for a large number of states, the set of components in the reference learning machine that have high degrees of importance to the reference learning machine's generation of outputs for only a small number of states, the set of components in the reference learning machine that have low degrees of importance to the reference learning machine when generating outputs, the degree of importance of each component of an input signal to the reference learning machine's generation of outputs associated with the possible states, and a description of why the reference learning machine generated particular outputs given particular input signals.

In some embodiments, the reference learning machine in the system may be a graph-based reference learning machine including but not limited to: neural networks, graph networks, sum-product networks, and Boltzmann machines, the components are nodes and interconnects, and the input signals can be grouped into one or more discrete states based on the outputs of the graph-based reference learning machine for a given input signal. The explainer learning machine being built for explaining and understanding the graph-based reference learning machine may comprise (1) an input signal component state importance assignment module, (2) a reference learning machine component state importance assignment module, (3) a reference learning machine component state importance classification module, (4) a set of matrices of parameters, with each matrix corresponding to a component in the reference learning machine, and each parameter in a matrix representing the normalized degree of importance of a component in the reference learning machine to the reference learning machine's generation of outputs given a particular state, and (5) a description generator module.

As used herein, a module may be implemented in software executable by one or more processors, in hardware or a combination thereof. Also as used herein, the term reference graph-based learning machine can be used interchangeably with the term graph-based reference learning machine.

The system may feed a set of test input signals through the reference graph-based learning machine and the outputs at each node in the reference graph-based learning machine for each given test input signal are recorded. The recorded outputs at each node in the graph-based learning machine for each given test input signal are then used to update each parameter in the set of parameter matrices in the explainer learning machine based on derived products of the recorded outputs along with the corresponding expected output of the reference graph-based learning machine for each given test input signal.

After the parameter update process, the explainer learning machine can then be queried for: (1) the degree of importance of each node in the reference learning machine to the reference learning machine's generation of outputs given the possible states, (2) the set of nodes in the reference learning machine that have high degrees of importance to the reference learning machine's generation of outputs for a large number of states, (3) the set of nodes in the reference learning machine that have high degrees of importance to the reference learning machine's generation of outputs for only a small number of states, (4) the set of nodes in the reference learning machine that have low degrees of importance to the reference learning machine when generating outputs, (5) the degree of importance of each component of an input signal to the reference learning machine's generation of outputs given the possible states, and (6) a description of why the reference learning machine generated particular outputs given particular input signals.

In some embodiments, to respond to the query for the degree of importance of each node in the reference graph-based learning machine to the reference graph-based learning machine's generation of outputs for input signals given the possible states, the reference learning machine component state importance assignment module may retrieve the parameters from the set of parameter matrices and return them as the query result.

In some embodiments, to respond to the query for the set of nodes in the reference learning machine that have high degrees of importance to the reference learning machine's generation of outputs for only a small number of states, the reference learning machine component state importance classification module may analyze the statistical properties of the set of parameters in the set of parameter matrices corresponding to each node in the reference learning machine, and return the set of nodes that have aggregated parameter values above a given classification threshold and parameter value variances below another classification threshold, where the classification thresholds are either learned or predefined. The dominant state for a given node, which is determined by the reference learning machine component state importance classification module as the state associated with the highest degree of importance amongst the possible states for a given node, may also be returned as part of the query result.

In some embodiments, to respond to the query for the set of nodes in the reference learning machine that have high degrees of importance to the reference learning machine's generation of outputs for a large number of states, the reference learning machine component state importance classification module may analyze the statistical properties of the set of parameters in the set of parameter matrices corresponding to each node in the reference learning machine, and return the set of nodes that have aggregated parameter values above a given classification threshold and parameter value variances above another classification threshold, where the classification thresholds are either learned or predefined.

In some embodiments, to respond to the query for the set of nodes in the reference learning machine that have low degrees of importance to the reference learning machine when generating outputs, the reference learning machine component state importance classification module may analyze the statistical properties of the set of parameters in the parameter matrices corresponding to each node in the reference learning machine, and return the set of nodes that would not be returned as query results for both nodes in the reference learning machine that have high degrees of importance to the reference learning machine's generation of outputs for only a small number of states and nodes in the reference learning machine that have high degrees of importance to the reference learning machine's generation of outputs for a large number of states.

In some embodiments, to respond to the query for the degree of importance of each component of an input signal to the reference learning machine's generation of outputs associated with the possible states, an input signal is fed through the reference graph-based learning machine and the outputs at each node of the reference graph-based learning machine for that test input signal are recorded. The recorded outputs at each node of the reference graph-based learning machine for that test input signal may then be fed, by the system, into the input signal component state importance assignment module, which queries the reference learning machine component state importance classification module for the set of nodes in the reference learning machine that have high degrees of importance to the reference learning machine's generation of outputs for only a small number of states, along with their dominant states. The input signal component state importance assignment module then may project derived products of the recorded outputs of the aforementioned set of nodes returned as query result by the reference learning machine component state importance classification module to the input signal domain, and these projected outputs may then be aggregated based on the dominant states of their associated nodes to determine the degree of importance of each component of an input signal to the reference learning machine's generation of outputs associated with the possible states. In some other embodiments, the values of a component of an input signal that has a degree of importance between a particular range may be replaced by alternative values to create an altered input signal, and the difference between the reference learning machine's outputs associated with the possible states when the input signal is fed through the reference learning machine and the reference learning machine's outputs associated with the possible states when the altered signal is fed through the reference learning machine may be computed and aggregated to provide an additional metric for the degree of importance of a component of an input signal to the reference learning machine's generation of outputs associated with the possible states. The range may include a lower bound and an upper bound, both may be set manually or determined in an automatic manner. By way of example, when an input signal (any input signal regardless of the source) is received by the reference learning machine, the reference learning machine will generate corresponding outputs (e.g., for an image classification network, the input signal is an image, and the output is the confidence that the image belongs to one of many categories). With the above described process, an additional metric may indicate how important each part of the input signal is to the corresponding output from the reference learning machine (e.g., in this example, this would tell how important different parts of the image is to the confidence that the image belongs to one of many categories, for example, it thinks it is a dog because of the tail part of the input image).

In some embodiments, to respond to the query for a description of why the reference learning machine generated particular outputs given an input signal, the input signal, the expected outputs, the outputs generated by the reference learning machine given the input signal, and the degree of importance of each component of an input signal to the reference learning machine's generation of outputs associated with the possible states responded by querying the explainer learning machine may be fed into the description generator module. The description generator module may construct a description (which can be in, but not limited to, text, image, audio format or a combination of these) of why the reference learning machine generated particular outputs given an input signal that comprises of, but not limited to, some combination of: the input signal, the expected outputs, the outputs generated by the reference learning machine given the input signal, the dominant state of each component of an input signal, and the location of each component of an input signal within the input signal.

In some other embodiments, the explainer learning machine being built for explaining and understanding the reference graph-based learning machine may comprise of (1) an input signal component state importance assignment module, (2) a reference learning machine component state importance assignment neural network, (3) a reference learning machine component state importance classification neural network, and (4) a description generator module.

The system may feed a set of test input signals through the reference graph-based learning machine and the outputs at each node of the reference graph-based learning machine for each given test input signal may be recorded. The recorded outputs at each node of the reference graph-based learning machine for each given test input signal may then be used to train the reference learning machine component state importance assignment neural network and the reference learning machine component state importance classification neural network based on derived products of the recorded outputs along with the corresponding expected output of the reference graph-based learning machine for each given test input signal.

In some embodiments, after the neural network training process, the explainer learning machine can then be queried for: the degree of importance of each node in the reference learning machine to the reference learning machine's generation of outputs given the possible states, the set of nodes in the reference learning machine that have high degrees of importance to the reference learning machine's generation of outputs for a large number of states, the set of nodes in the reference learning machine that have high degrees of importance to the reference learning machine's generation of outputs for only a small number of states, the set of nodes in the reference learning machine that have low degrees of importance to the reference learning machine when generating outputs, and the degree of importance of each component of an input signal to the reference learning machine's generation of outputs given the possible states.

In some embodiments, to respond to the query for the degree of importance of each node of the reference graph-based learning machine to the reference graph-based learning machine's generation of outputs for input signals given the possible states, the reference learning machine component state importance assignment network is fed the derived products of the recorded outputs of each node along with the corresponding expected output of the graph-based learning machine for each given test input signal, and returns the network output (which is the degree of importance for each possible state) as the query result.

In some embodiments, to respond to the query for the set of nodes in the reference graph-based learning machine that have high degrees of importance to the reference learning machine's generation of outputs for only a small number of states, the reference learning machine component state importance classification network may be fed the degree of importance of each node in the reference graph-based learning machine to the reference graph-based learning machine's generation of outputs for input signals given the possible states from the reference learning machine component state importance assignment network, and the network outputs of which the states each node is associated with. In some embodiments, each node may be associated with three states (1. Node has high degree of importance to a large number of states, 2. Node has high degree of importance to a small number of states, and 3. Node with low degree of importance to reference learning machine's output generation). The set of nodes classified as being nodes with high degree of importance to a small number of states may be returned as the query result. The dominant state for a given node, which is determined from the output of the reference learning machine component state importance assignment network as the state associated with the highest degree of importance amongst the possible states for a given node, may also be returned as part of the query result.

In some embodiments, to respond to the query for the set of nodes in the reference learning machine that have high degrees of importance to the reference learning machine's generation of outputs for a large number of states, the reference learning machine component state importance classification network may be fed the degree of importance of each node of the reference graph-based learning machine to the reference graph-based learning machine's generation of outputs for input signals given the possible states from the reference learning machine component state importance assignment network, and the network outputs of which the states each node is associated with. In some embodiments, each node may be associated with three states (1. Node has high degree of importance to a large number of states, 2. Node has high degree of importance to a small number of states, and 3. Node with low degree of importance to reference learning machine's output generation). The set of nodes classified as being nodes with high degree of importance to a large number of states may be returned as the query result.

In some embodiments, to respond to the query for the set of nodes in the reference learning machine that have low degrees of importance to the reference learning machine when generating outputs, the reference learning machine component state importance classification network may be fed the degree of importance of each node of the reference graph-based learning machine to the reference graph-based learning machine's generation of outputs for input signals given the possible states from the reference learning machine component state importance assignment network, and the network outputs of which the states each node is associated with. In some embodiments, each node may be associated with three states (1. Node has high degree of importance to a large number of states, 2. Node has high degree of importance to a small number of states, and 3. Node with low degree of importance to reference learning machine's output generation). The set of nodes classified as being nodes with low degree of importance may be returned as the query result.

In some embodiments, to respond to the query for the degree of importance of each component of an input signal to the reference learning machine's generation of outputs associated with the possible states, an input signal may be fed through the reference graph-based learning machine and the outputs at each node of the graph-based learning machine for that test input signal may be recorded. The recorded outputs at each node of the graph-based learning machine for that test input signal may then be fed into the input signal component state importance assignment module, which queries the reference learning machine component state importance classification network for the set of nodes in the reference learning machine that have high degrees of importance to the reference learning machine's generation of outputs for only a small number of states, along with their dominant states. The input signal component state importance assignment module may then project derived products of the recorded outputs of the aforementioned set of nodes returned as query result by the reference learning machine component state importance classification module to the input signal domain, and these projected outputs may then be aggregated based on the dominant states of their associated nodes to determine the degree of importance of each component of an input signal to the reference learning machine's generation of outputs associated with the possible states. In some other embodiments, the values of a component of an input signal that has a degree of importance between a particular range may be replaced by alternative values to create an altered input signal, and the difference between the reference learning machine's outputs associated with the possible states when the input signal is fed through the reference learning machine and the reference learning machine's outputs associated with the possible states when the altered signal is fed through the reference learning machine may be computed and aggregated to provide an additional metric for the degree of importance of a component of an input signal to the reference learning machine's generation of outputs associated with the possible states. The range may include a lower bound and an upper bound, both may be set manually or determined in an automatic manner.

In some embodiments, to respond to the query for a description of why the reference learning machine generated particular outputs given an input signal, the input signal, the expected outputs, the outputs generated by the reference learning machine given the input signal, and the degree of importance of each component of an input signal to the reference learning machine's generation of outputs associated with the possible states responded by querying the explainer learning machine may be fed into the description generator module. The description generator module may construct a description (which can be in, but not limited to, text, image, audio format or a combination of these) of why the reference learning machine generated particular outputs given an input signal that comprises of, but not limited to, some combination of: the input signal, the expected outputs, the outputs generated by the reference learning machine given the input signal, the dominant state of each component of an input signal, and the location of each component of an input signal within the input signal.

In some embodiments, the reference learning machine and the explainer learning machine built for explaining and understanding the reference learning machine may be embodied in software, or in hardware in the form of an integrated circuit chip, a digital signal processor chip, or on a computing device, or a combination thereof.

In this respect, before explaining at least one embodiment of the disclosure in detail, it is to be understood that the disclosure is not limited in its application to the details of construction and to the arrangements of the components set forth in the following description or the examples provided therein or illustrated in the drawings. Therefore, it will be appreciated that a number of variants and modifications can be made without departing from the teachings of the disclosure as a whole. Therefore, the present system, method and apparatus is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

As noted above, the present disclosure provides practical applications and technical improvements to the field of machine learning, and more specifically to systems and methods for building and using learning machines for understanding and explaining learning machines.

The present system and method will be better understood, and objects of the disclosure will become apparent, when consideration is given to the following detailed description thereof. Such description makes reference to the annexed drawings, wherein:

FIG. 1 shows a system in accordance with an illustrative embodiment, comprising a reference learning machine, an explainer learning machine, and an entity making queries to the explainer learning machine.

FIG. 2 shows a system in accordance with an illustrative embodiment, comprising a reference graph-based learning machine, an explainer learning machine, and an entity making queries to the explainer learning machine.

FIGS. 3A(1) and 3A(2) show an illustrative embodiment of an explainer learning machine of an input signal component state importance assignment module, a reference learning machine component state importance assignment module, a reference learning machine component state importance classification module, a set of matrices of parameters, and a description generator module.

FIG. 3B shows an illustrative embodiment of a high-level diagram of an explainer learning machine.

FIGS. 4A(1) and 4A(2) shows an illustrative embodiment of an input signal component state importance assignment module, a reference learning machine component state importance assignment neural network, a reference learning machine component state importance classification neural network, and a description generator module.

FIG. 4B shows an illustrative embodiment of a high-level diagram of an explainer learning machine using neural networks.

FIG. 5(a) shows an illustrative embodiment of an example visualization of the degree of importance (shown in terms of brightness of a node, with brighter being more important) and the dominant class label state (shown as a label number below a node) of the individual nodes at different layers of a classification neural network.

FIG. 5(b) shows an illustrative embodiment of example image input signals to a classification neural network, overlaid with a visualization of the degree of importance of the different parts of an image to each class label state in the classification neural network.

FIG. 5(c) shows an illustrative embodiment of example image input signals to a classification neural network, aggregated with a soft mask of a visualization of the degree of importance of the different parts of an image to each class label state in the classification neural network as determined by the explainer learning machine.

FIG. 5(d) shows an illustrative embodiment of an example visualization of the degree of importance (shown in terms of brightness of a layer, with darker being more important) of individual layers of a classification neural network, as determined by the explainer learning machine, with alerts shown for layers with low degree of importance.

FIG. 5(e) shows an illustrative embodiment of example changes in decision confidence scores of a stock price rise/fall prediction deep neural network when factors (opening price, closing price, highest price, lowest price, and trade volume) at certain dates (highlighted in red) with importance between a lower bound and upper bound are altered.

FIG. 6(a) shows an illustrative embodiment of example visualizations of the histogram of the degree of importance of nodes at one of the layers of a classification neural network as determined by an explainer learning machine.

FIG. 6(b) shows an illustrative embodiment of example visualizations of the degree of importance (shown in terms of brightness of a node, with brighter being more important) of the individual nodes at one of the layers of a classification neural network as determined by an explainer learning machine.

FIG. 6(c) shows an illustrative embodiment of example visualizations of the scatter plot of the dominant class state distribution of nodes at one of the layers of a classification neural network.

FIGS. 6(d)(1) and 6(d)(2) show an illustrative embodiment of example visualizations of components (i.e., regions of interest) of an example image input signal that has a degree of importance between a lower bound lb and upper bound ub for a classification neural network, along with the changes in decision confidence scores of a classification neural network for possible decision states (i.e., classes) when components (i.e., regions of interest) of an example image input signal that has a degree of importance between a lower bound and upper bound are altered.

FIG. 6(e) shows an illustrative embodiment of example visualizations of a visualization and text description of why a car steering neural network decided to steer right given an image input signal.

FIG. 6(f) shows an illustrative embodiment of example visualizations of a visualization and text description of why a transaction fraud detection neural network decided that a transaction was fraudulent given an input transaction.

FIG. 6(g) shows an illustrative embodiment of example visualizations of a visualization of why a stock price rise/fall prediction deep neural network decided that a stock will fall due to certain important factors (opening price, closing price, highest price, lowest price, and trade volume) at certain dates (highlighted in green).

FIG. 6(h) shows an illustrative embodiment of example visualizations of a visualization of the differences in what components (i.e., regions of interest) are considered important to two different classification neural networks.

FIG. 7 shows an illustrative embodiment of a schematic block diagram of a generic computing device which may provide an operating environment for various embodiments of the present disclosure.

In the drawings, embodiments are illustrated by way of example. It is to be expressly understood that the description and drawings are only for the purpose of illustration and as an aid to understanding and are not intended as describing the accurate performance and behavior of the embodiments and a definition of the limits of the invention.

### DETAILED DESCRIPTION

The present disclosure relates to systems and methods for building and using learning machines to understand and explain learning machines.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

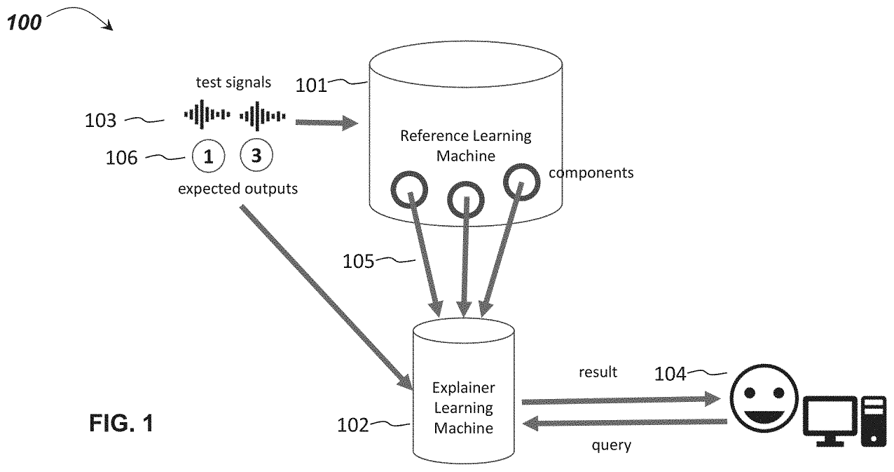

In an aspect, with reference to FIG. 1, shown is an illustrative example of a system 100 in accordance with an illustrative embodiment. In some embodiments, the present system may comprise a reference learning machine 101 and an explainer learning machine 102 being built for explaining and understanding the reference learning machine. The reference learning machine 101 may include but are not limited to sum-product networks, Bayesian networks, Boltzmann machines, and neural networks. Input signals can be grouped into one or more discrete states based on the outputs of the learning machine for a given input signal. In some embodiments, a set of test input signals 103 are fed through the reference learning machine 101 and the outputs 105 at the different components of the learning machine for each given test input signal are recorded. The recorded outputs 105 at the different components of the learning machine 101 for each given test input signal 103, along with the corresponding expected output 106 of the learning machine 101 for each given test input signal 103, are then used to update the parameters (as described further below) of the explainer learning machine 102. After the parameter update process, the explainer learning machine 102 can then be queried by an entity 104 (including but not limited to a user or a computer) for quantitative insights about the reference learning machine that include, but not limited to: (1) the degree of importance of each component of the reference learning machine to the reference learning machine's generation of outputs for input signals associated with the possible states, (2) the set of components in the reference learning machine that have high degrees of importance to the reference learning machine's generation of outputs for a large number of states, (3) the set of components in the reference learning machine that have high degrees of importance to the reference learning machine's generation of outputs for only a small number of states, (4) the set of components in the reference learning machine that have low degrees of importance to the reference learning machine when generating outputs, (5) the degree of importance of each component of an input signal to the reference learning machine's generation of outputs associated with the possible states, and (6) a description of why the reference learning machine generated particular outputs given particular input signals.

In some embodiments, the reference learning machine 101 and the explainer learning machine 102 may be embodied in hardware in the form of an integrated circuit chip, a digital signal processor chip, or on a computer. Learning machines may be also embodied in hardware in the form of an integrated circuit chip or on a computer.

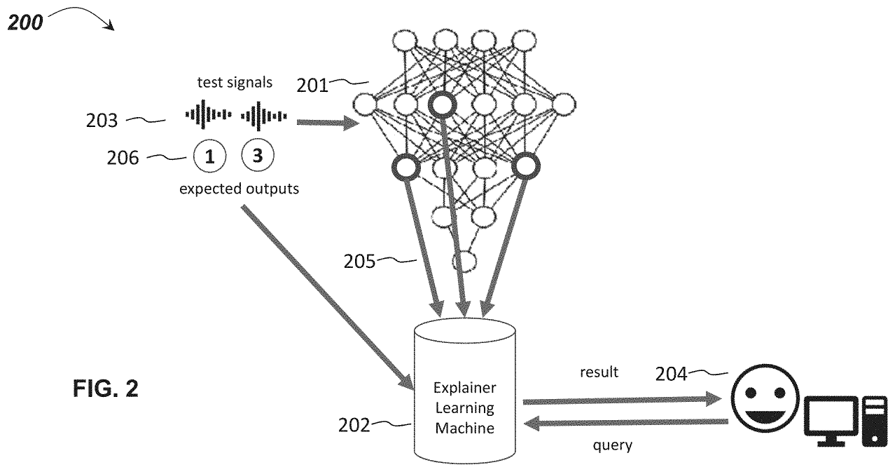

With reference to FIG. 2, shown is an illustrative example of a system 200 in accordance with an illustrative embodiment. In this example, the reference learning machine 201 is a graph-based learning machine, including but not limited to neural networks, graph networks, sum-product networks, and Boltzmann machines, the components are nodes and interconnects, and the input signals can be grouped into one or more discrete states based on the outputs of the graph-based learning machine for a given input signal. The present system may comprise a reference graph-based learning machine 201 and an explainer learning machine 202 being built for explaining and understanding the reference learning machine. The input signals can be grouped into one or more discrete states based on the outputs of the learning machine for a given input signal. In some embodiments, a set of test input signals 203 are fed through the reference learning machine 201 and the outputs 205 at the different nodes of the learning machine for each given test input signal are recorded. The recorded outputs at the different nodes of the learning machine 205 for each given test input signal, along with the corresponding expected output 206 of the learning machine for each given test input signal are then used to update the parameters of the explainer learning machine 202. After the parameter update process, the explainer learning machine 202 can then be queried by an entity 204 (including but not limited to a user or a computer) for quantitative insights about the reference learning machine that include, but not limited to: the degree of importance of each node of the reference learning machine to the reference learning machine's generation of outputs for input signals associated with the possible states, the set of nodes in the reference learning machine that have high degrees of importance to the reference learning machine's generation of outputs for a large number of states, the set of nodes in the reference learning machine that have high degrees of importance to the reference learning machine's generation of outputs for only a small number of states, the set of nodes in the reference learning machine that have low degrees of importance to the reference learning machine when generating outputs, the degree of importance of each component of an input signal to the reference learning machine's generation of outputs associated with the possible states, and a description of why the reference learning machine generated particular outputs given particular input signals.

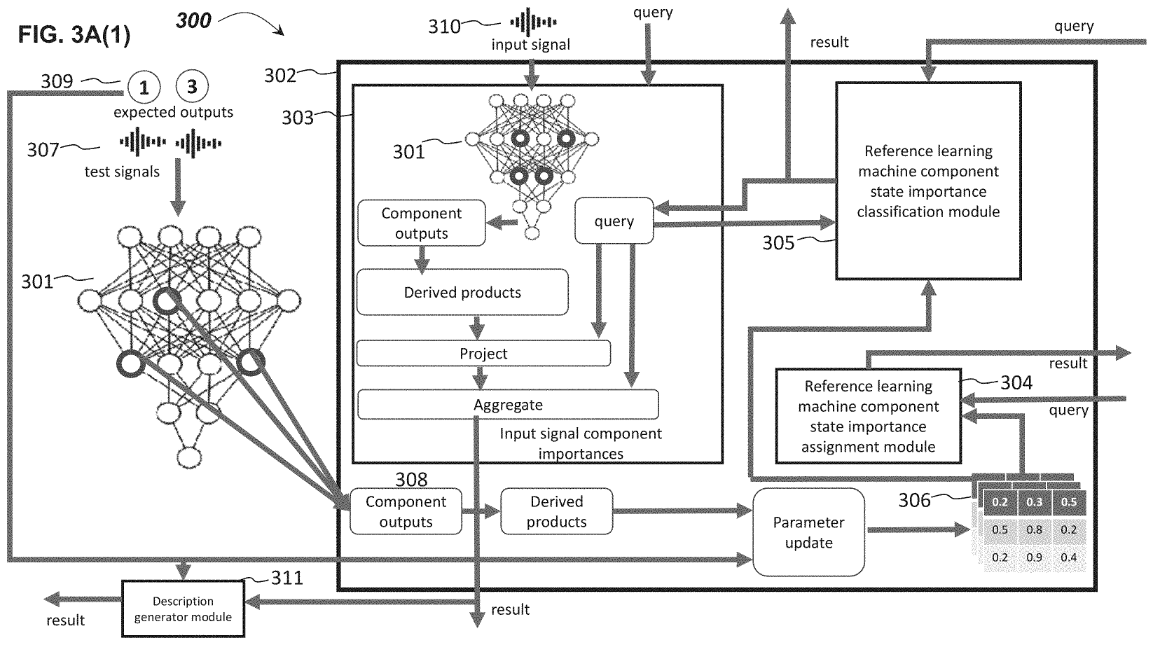

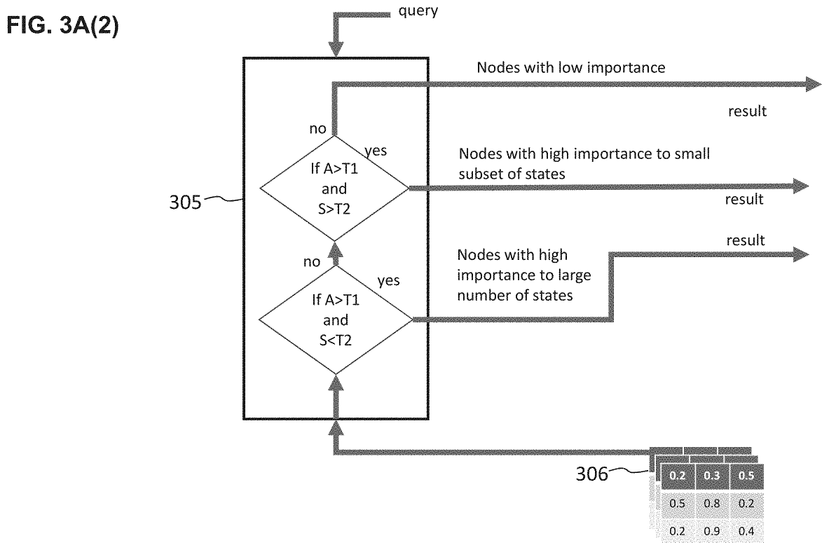

With reference to FIGS. 3A(1) and 3A(2), shown is an illustrative example 300 of an explainer learning machine in accordance with an illustrative embodiment. In some embodiments, the explainer learning machine 302 being built for explaining and understanding the reference graph-based learning machine 301 may comprise an input signal component state importance assignment module 303, a reference learning machine component state importance assignment module 304, a reference learning machine component state importance classification module 305, a set of matrices of parameters 306, with each matrix corresponding to a component in the reference learning machine 301, and each parameter in a matrix representing the normalized degree of importance of a node in the reference learning machine to the reference learning machine's generation of outputs given a particular state, and a description generator module 311. A set of test input signals 307 is fed through the reference graph-based learning machine 301 and the outputs 308 at each node of the graph-based learning machine for each given test input signal are recorded. The recorded outputs 308 at each node of the graph-based learning machine for each given test input signal are then used to update each parameter in the set of parameter matrices 306 in the explainer learning machine based on derived products of the recorded outputs along with the corresponding expected output 309 of the graph-based learning machine 301 for each given test input signal 307. Derived products may include, but not limited to: mean of outputs, maximum of outputs, median of outputs, weighted sum of outputs, mean of gradients, maximum of gradients, median of gradients, weighted sum of gradients, mean of integrated gradients, maximum of integrated gradients, median of integrated gradients, weighted sum of integrated gradients, conductance, entropy, mutual information, quantized mean of outputs, quantized maximum of outputs, quantized median of outputs, quantized weighted sum of outputs, quantized mean of gradients, quantized maximum of gradients, quantized median of gradients, quantized weighted sum of gradients, quantized mean of integrated gradients, quantized maximum of integrated gradients, quantized median of integrated gradients, quantized weighted sum of integrated gradients, quantized entropy, quantized mutual information, and quantized conductance. In some embodiments, the parameter update process for updating a parameter P_{node i,state j} in the set of parameter matrices may involve: 1) the weighted summation of all derived products of the recorded outputs of node i in the reference learning machine corresponding to all test input signals associated with state j, 2) division of the resulting weighted summation by the maximum weighted summation across all states for node i. Note that this is an illustrative embodiment for updating a parameter and is not limited to the particular embodiments described. After the parameter update process, the explainer learning machine 302 can then be queried for: the degree of importance of each node of the reference learning machine to the reference learning machine's generation of outputs given the possible states, the set of nodes in the reference learning machine that have high degrees of importance to the reference learning machine's generation of outputs for a large number of states, the set of nodes in the reference learning machine that have high degrees of importance to the reference learning machine's generation of outputs for only a small number of states, the set of nodes in the reference learning machine that have low degrees of importance to the reference learning machine when generating outputs, the degree of importance of each component of an input signal to the reference learning machine's generation of outputs given the possible states, and a description of why the reference learning machine generated particular outputs given particular input signals.

In some embodiments, to respond to the query for the degree of importance of each node of the reference graph-based learning machine to the reference graph-based learning machine's generation of outputs for input signals given the possible states, the reference learning machine component state importance assignment module 304 may retrieve the parameters from the set of parameter matrices 306 and return them as the query result.

In some embodiments, to respond to the query for the set of nodes in the reference learning machine that have high degrees of importance to the reference learning machine's generation of outputs for only a small number of states, the reference learning machine component state importance classification module 305 may analyze the statistical properties of the set of parameters P_{node i,state 1}, P_{node i,state 2}, . . . , P_{node i,state k} (where k is the number of possible states) in the set of parameter matrices corresponding to each node i in the reference learning machine, and return the set of nodes that have aggregated parameter values (A) above a given classification threshold T1 and parameter value variances (S) below another classification threshold T2, where the classification thresholds are either learned or predefined. In some embodiments, the aggregated parameter value A_i for node i may be determined as the average parameter value across all states for node i and the parameter value variance S_i for node i may be determined as the variance of parameter values across all states for node i. Note that this is an illustrative embodiment for updating a parameter and is not limited to the particular embodiments described. The dominant state for a given node, which is determined by the reference learning machine component state importance classification module as the state associated with the highest degree of importance amongst the possible states for a given node, may also be returned as part of the query result.

In some embodiments, to respond to the query for the set of the nodes in the reference learning machine that have high degrees of importance to the reference learning machine's generation of outputs for a large number of states, the reference learning machine component state importance classification module 305 may analyze the statistical properties of the set of parameters in the set of parameter matrices corresponding to each node in the reference learning machine, and return the set of nodes that have aggregated parameter values (A) above a given classification threshold T1 and parameter value variances (S) above another classification threshold T2, where the classification thresholds are either learned or predefined.

In some embodiments, to respond to the query for the set of nodes in the reference learning machine that has low degrees of importance to the reference learning machine when generating outputs, the reference learning machine component state importance classification module 305 may analyze the statistical properties of the set of parameters in the parameter matrices corresponding to each node in the reference learning machine, and return that set of the nodes that would not be returned as query results for both the set of nodes in the reference learning machine that have high degrees of importance to the reference learning machine's generation of outputs for only a small number of states and the set of nodes in the reference learning machine that have high degrees of importance to the reference learning machine's generation of outputs for a large number of states.

In some embodiments, to respond to the query for the degree of importance of each component of an input signal to the reference learning machine's generation of outputs associated with the possible states, a test input signal 310 may be fed through the reference graph-based learning machine and the outputs at each node of the graph-based learning machine for that test input signal 310 are recorded. The recorded outputs at each node of the graph-based learning machine for that test input signal may then be fed into the input signal component state importance assignment module 303, which queries the reference learning machine component state importance classification module 305 for the set of nodes in the reference learning machine that have high degrees of importance to the reference learning machine's generation of outputs for only a small number of states, along with their dominant states. The input signal component state importance assignment module 303 may then project derived products of the recorded outputs of the aforementioned set of nodes returned as query result by the reference learning machine component state importance classification module to the input signal domain, and these projected outputs may then be aggregated based on the dominant states of their associated nodes to determine the degree of importance of each component of an input signal to the reference learning machine's generation of outputs associated with the possible states. In some embodiments, the input signal domain may be defined as the domain in which the input signal that is fed into the graph-based learning machine is expressed. For example, in the case where the input signal is a digital image, the input signal domain may be the spatial domain. In another example, in the case where the input signal is a digital audio signal, the input signal domain may be the time domain or the frequency domain.

In some other embodiments, the values of a component of an input signal 310 that has a degree of importance between a particular range may be replaced by alternative values to create an altered input signal. In an illustrative embodiment, the values of a component of an input signal 310 that has a degree of importance between a lower bound lb and upper bound ub are set to zero to create an altered input signal. In another illustrative embodiment, the values of a component of an input signal that has a degree of importance between a lower bound lb and upper bound ub are set to a random value U generated by a random number generator to create an altered input signal A. It is important to note that other alternative values may be used, and the above example embodiments are not meant to be limiting. It is also important to note that the lower bound lb and upper bound ub may be set manually or determined in an automatic manner. The difference between the reference learning machine's outputs O_I associated with the possible states when the input signal 310 may be fed through the reference learning machine and the reference learning machine's outputs O_A associated with the possible states when the altered signal A is fed through the reference learning machine is computed and aggregated to provide an additional metric M for the degree of importance of a component of an input signal to the reference learning machine's generation of outputs associated with the possible states.

M=J(O_I−O_A)

In an illustrative embodiment, the metric I can be defined as the squared error between O_I and O_A:

M=(O_I−O_A)\hat{ }2

In another illustrative embodiment, the metric I can be defined as the absolute error between O_I and O_A:

M=|O_I−O_A|

It is important to note that other alternative metrics may be used, and the above example embodiments are not meant to be limiting.

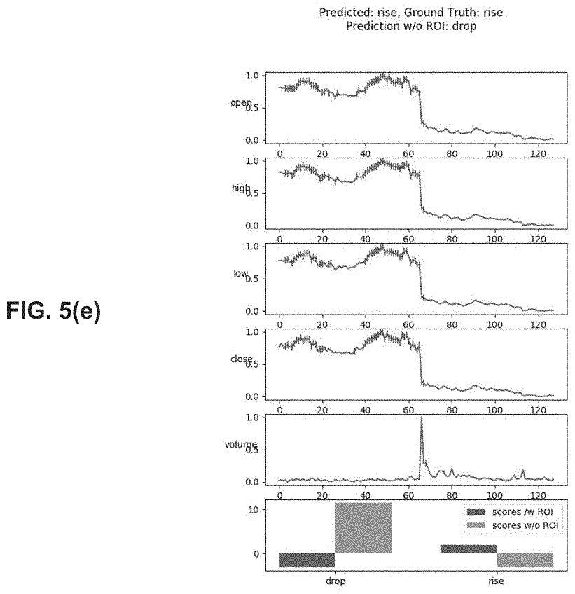

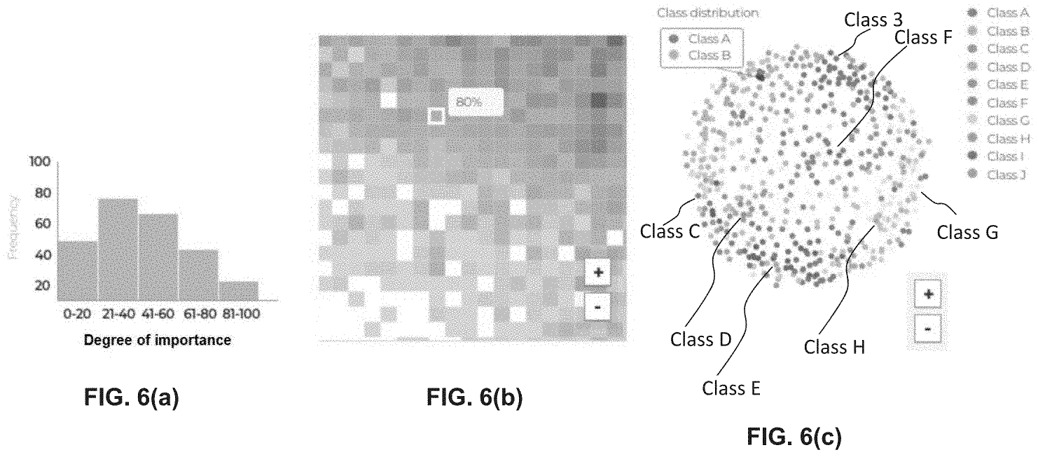

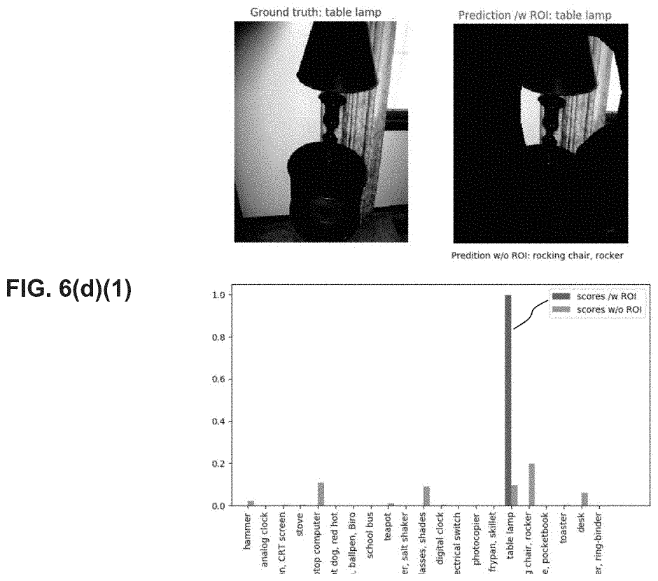

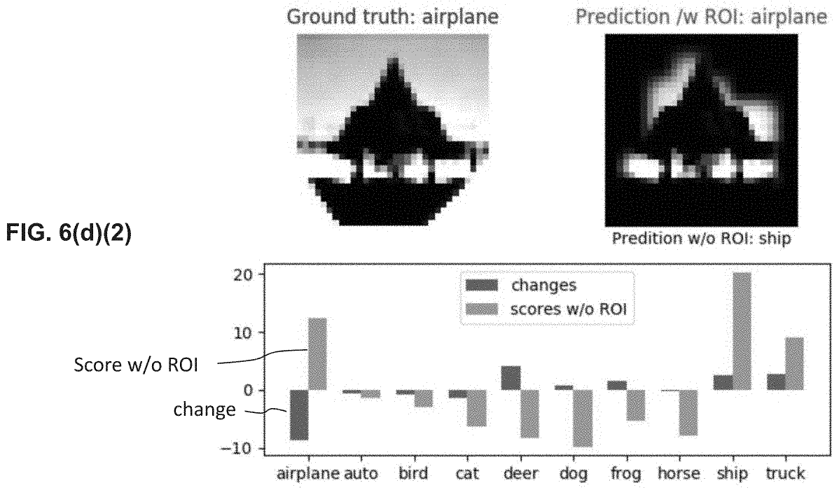

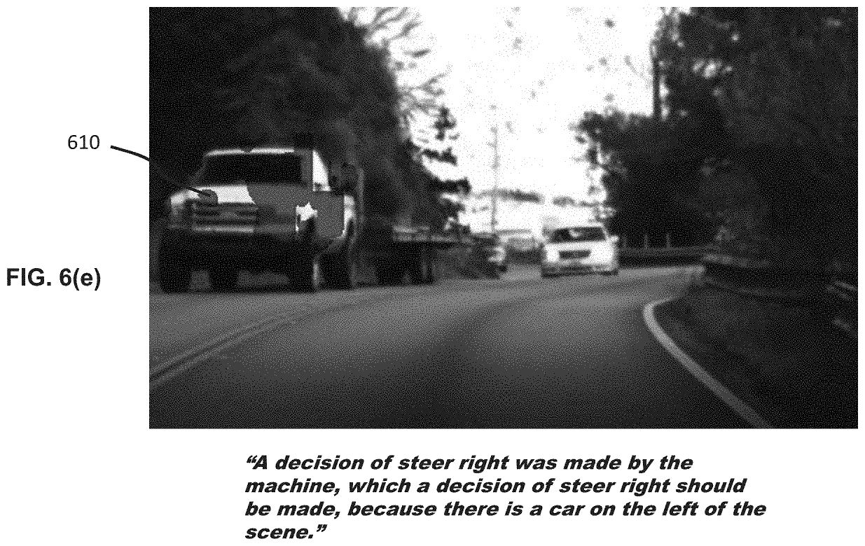

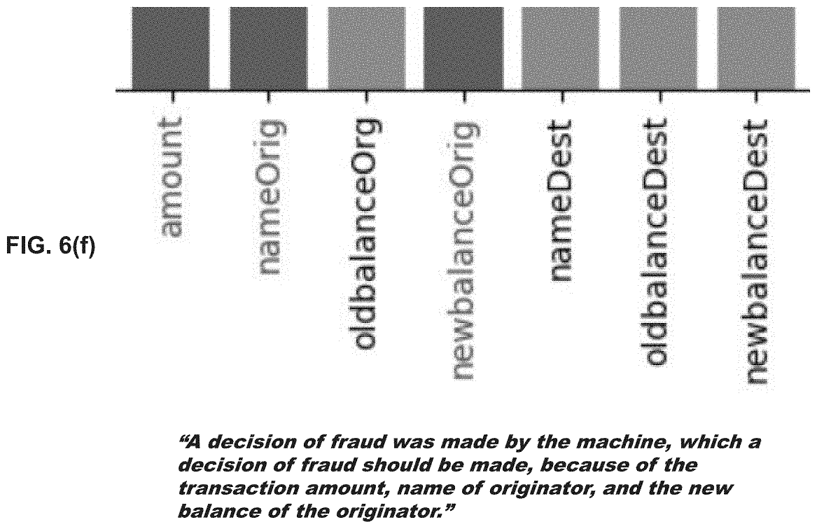

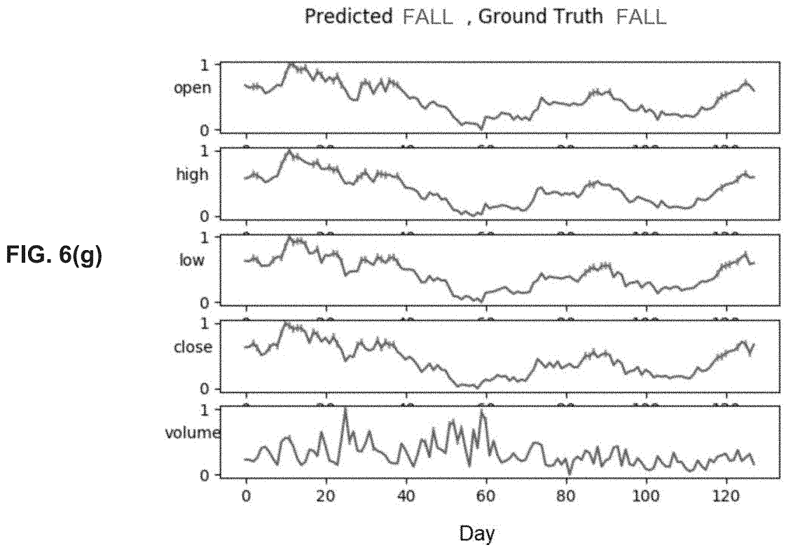

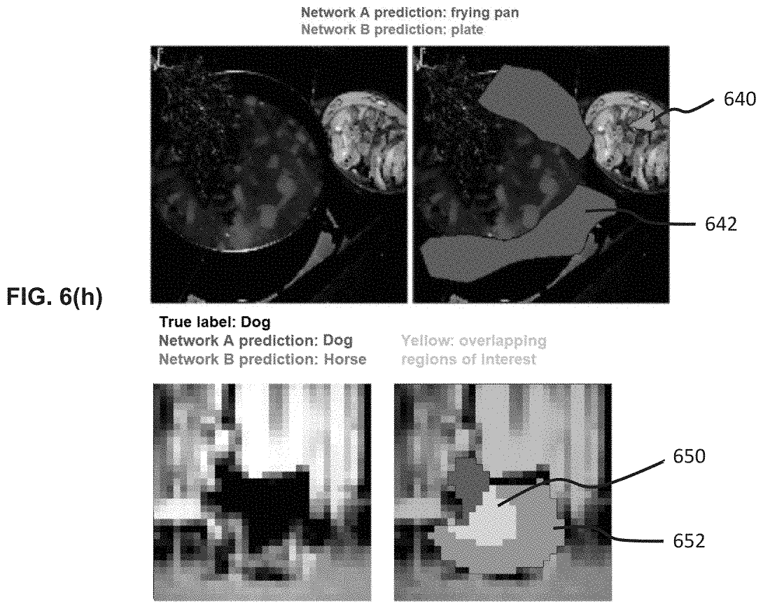

In some embodiments, to respond to the query for a description of why the reference learning machine generated particular outputs given an input signal, the input signal 310, the expected outputs 309, the outputs generated by the reference learning machine given the input signal, and the degree of importance of each component of an input signal to the reference learning machine's generation of outputs associated with the possible states responded by querying the explainer learning machine may be fed into the description generator module 311. The description generator module 311 may construct a description (which can be in, but not limited to, text, image, audio format or a combination of these) of why the reference learning machine generated particular outputs given an input signal 310 that comprises of, but not limited to, some combination of: the input signal 310, the expected outputs 309, the outputs generated by the reference learning machine given the input signal, the dominant state of each component of an input signal that has a degree of importance between a lower bound lb and upper bound ub, and the location of each component of an input signal within the input signal. In an illustrative example where the reference learning machine is a neural network for determining if a car should steer left or right, where the input signal 310 is an image captured from a camera on a car, and the output is either a decision of ‘steer left’ or ‘steer right’, and expected output is either a decision of ‘steer left’ or ‘steer right’, and components of the input signal are objects (such as cars, posts, lane markings, tree, pedestrian, etc.) in the image, the description generator module 311 may construct a text description of why the reference learning machine generated particular outputs given an input signal in the following form:
“A decision of [‘steer left’/‘steer right’] was made by the machine, which a decision of [‘steer left’/‘steer right’] should be made, because there is a [‘car’/‘post’/‘lane markings’/‘tree’/ . . . ] on the [‘top left’/‘top’/‘top right’/‘left’/‘middle’/‘right’/‘bottom left’/‘bottom’/‘bottom right’] of the scene, and . . . .” (See also FIG. 6(e)).

In another illustrative example where the reference learning machine is a neural network for determining if a concentration of chlorine is problematic or not problematic, where the input signal 310 is the chlorine levels at different pipe junctions at different times, and the output is either a decision of ‘problematic’ or ‘not problematic’, and expected output is either a decision of ‘problematic’ or ‘not problematic’, and components of the input signal are chlorine levels at different pipe junctions at different times, the description generator module 311 may construct a text description of why the reference learning machine generated particular outputs given an input signal in the following form:
“A decision of [‘problematic’/‘not problematic’] was made by the machine, which a decision of [‘problematic’/‘not problematic’] should be made, because the concentration of chlorine is [X] at pipe junction [Y] at time [T], and . . . .”

In yet another illustrative example where the reference learning machine is a neural network for determining if a stock is a ‘buy’ or a ‘sell’, where the input signal 310 is the closing stock prices at different times, and the output is either a decision of ‘buy’ or ‘sell’, and expected output is either a decision of ‘buy’ or ‘sell’, and components of the input signal are closing stock prices, open stock prices, and trade volumes at different times, the description generator module 311 may construct a text description of why the reference learning machine generated particular outputs given an input signal in the following form:
“A decision of [‘buy’/‘sell’] was made by the machine, which a decision of [‘buy’/‘sell’] should be made, because the [‘closing stock price’/‘opening stock price’/‘trade volume’] is [X1] at time [T1], and the [‘closing stock price’/‘opening stock price’/‘trade volume’] is [X2] at time [T2], and . . . .”

It is important to note that other alternative description formats may be used, and the above example embodiments are not meant to be limiting.

With reference to FIG. 3B, a high-level flowchart of process 380 of an explainer learning machine 302 for when the query is for the input signal component, importance is shown, in accordance with an illustrative embodiment. At Step 382, the system may receive one or more input signals 310. At Step 384, the system may pass the one or more input signals 310 to a reference learning machine 301. At Step 386, the system may feed one or more component outputs of the reference learning machine 301 to the input signal component state importance assignment module 303. In this example, at Step 388, the reference learning machine component state importance classification module 305 may receive a query, for example from an entity (including but not limited to a user or a computer), for a set of nodes in the reference learning machine 301 with high degree of importance, and with corresponding dominant states. At Step 390 the system may project derived products of the outputs of the set of nodes returned as query result by the reference learning machine component state importance classification module 305 to the input signal domain to obtain one or more projected outputs. At Step 392, the system may aggregate these projected outputs based on the dominant states of their associated nodes to determine the degree of importance of each component of an input signal 310 to the reference learning machine's generation of outputs associated with the possible states. At Step 394, the system may return, as result to the query, the degree of importance of each component of the input signals 310 to the reference learning machine's generation of outputs associated with the possible states.

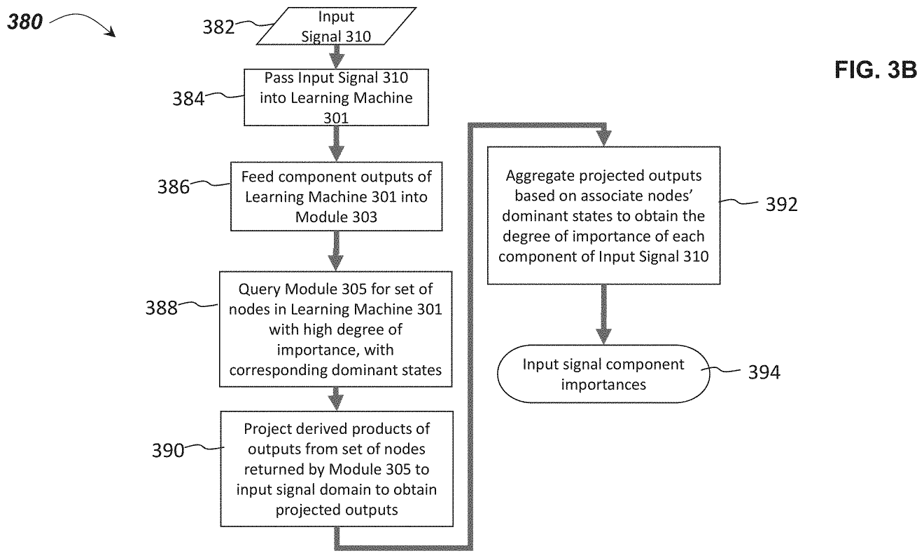

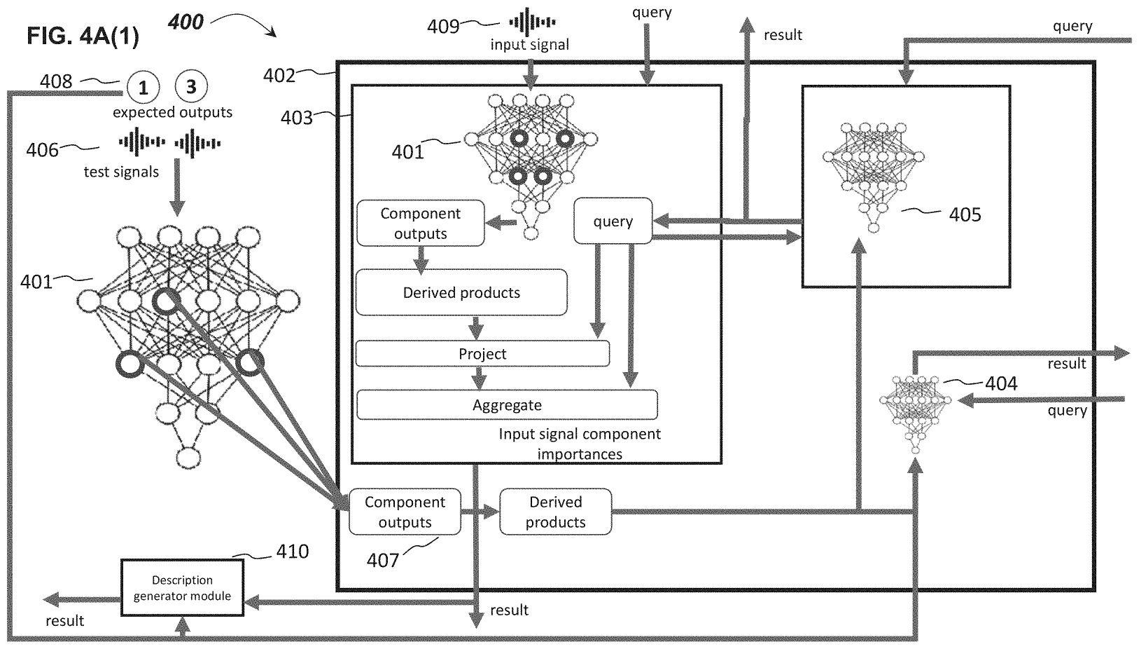

With reference to FIGS. 4A(1) and 4A(2), shown is an illustrative example 400 of an explainer learning machine in accordance with an illustrative embodiment. The explainer learning machine 402 being built for explaining and understanding the reference graph-based learning machine 401 may comprise an input signal component state importance assignment module 403, a reference learning machine component state importance assignment neural network 404, a reference learning machine component state importance classification neural network 405, and a description generator module 410. A set of test input signals 406 may be fed through the reference graph-based learning machine 401 and the outputs at each node of the graph-based learning machine for each given test input signal may be recorded 407. The recorded outputs at each node of the graph-based learning machine 407 for each given test input signal may then be used to train the reference learning machine component state importance assignment neural network 404 and the reference learning machine component state importance classification neural network 405 based on derived products of the recorded outputs along with the corresponding expected output 408 of the graph-based learning machine for each given test input signal 406. Derived products may include, but not limited to: mean of outputs, maximum of outputs, median of outputs, weighted sum of outputs, mean of gradients, maximum of gradients, median of gradients, weighted sum of gradients, mean of integrated gradients, maximum of integrated gradients, median of integrated gradients, weighted sum of integrated gradients, conductance, entropy, mutual information, quantized mean of outputs, quantized maximum of outputs, quantized median of outputs, quantized weighted sum of outputs, quantized mean of gradients, quantized maximum of gradients, quantized median of gradients, quantized weighted sum of gradients, quantized mean of integrated gradients, quantized maximum of integrated gradients, quantized median of integrated gradients, quantized weighted sum of integrated gradients, quantized entropy, quantized mutual information, and quantized conductance. After the neural network training process, the explainer learning machine can then be queried for: the degree of importance of each node of the reference learning machine to the reference learning machine's generation of outputs given the possible states, the nodes in the reference learning machine that have high degrees of importance to the reference learning machine's generation of outputs for a large number of states, the nodes in the reference learning machine that have high degrees of importance to the reference learning machine's generation of outputs for only a small number of states, the nodes in the reference learning machine that have low degrees of importance to the reference learning machine when generating outputs, the degree of importance of each component of an input signal to the reference learning machine's generation of outputs given the possible states, and a description of why the reference learning machine generated particular outputs given particular input signals.

In some embodiments, to respond to the query for the degree of importance of each node of the reference graph-based learning machine to the reference graph-based learning machine's generation of outputs for input signals given the possible states, the reference learning machine component state importance assignment network 404 may be fed the derived products of the recorded outputs of each node along with the corresponding expected output 408 of the graph-based learning machine for each given test input signal 406, and returns the network output (which is the degree of importance for each possible state) as the query result.

In some embodiments, to respond to the query for the nodes in the reference learning machine that have high degrees of importance to the reference learning machine's generation of outputs for only a small number of states, the reference learning machine component state importance classification network 405 may be fed the degree of importance of each node of the reference graph-based learning machine to the reference graph-based learning machine's generation of outputs for input signals given the possible states from the reference learning machine component state importance assignment network 404, and the network outputs of which states each node is associated with. In some embodiments, each node may be associated with three states (1. Node has high degree of importance to a large number of states, 2. Node has high degree of importance to a small number of states, and 3. Node with low degree of importance to reference learning machine's output generation). The set of nodes classified as being nodes with high degree of importance to a small number of states may be returned as the query result. The dominant state for a given node, which is determined from the output of the reference learning machine component state importance assignment network 404 as the state which a given node has the highest degree of importance amongst the possible states, may also be returned as part of the query result.

In some embodiments, to respond to the query for the nodes in the reference learning machine that have high degrees of importance to the reference learning machine's generation of outputs for a large number of states, the reference learning machine component state importance classification network 405 may be fed the degree of importance of each node of the reference graph-based learning machine to the reference graph-based learning machine's generation of outputs for input signals given the possible states from the reference learning machine component state importance assignment network 404, and the network outputs of which states each node is associated with. In some embodiments, each node may be associated with three states (1. Node has high degree of importance to a large number of states, 2. Node has high degree of importance to a small number of states, and 3. Node with low degree of importance to reference learning machine's output generation). The set of nodes classified as being nodes with high degree of importance to a large number of states may be returned as the query result.

In some embodiments, to respond to the query for the nodes in the reference learning machine that have low degrees of importance to the reference learning machine when generating outputs, the reference learning machine component state importance classification network 405 may be fed the degree of importance of each node of the reference graph-based learning machine to the reference graph-based learning machine's generation of outputs for input signals given the possible states from the reference learning machine component state importance assignment network 404, and the network outputs of which states each node is associated with. In some embodiments, each node may be associated with three states (1. Node has high degree of importance to a large number of states, 2. Node has high degree of importance to a small number of states, and 3. Node with low degree of importance to reference learning machine's output generation). The set of nodes classified as being nodes with low degree of importance are returned as the query result.

In some embodiments, to respond to the query for the degree of importance of each component of an input signal 409 to the reference learning machine's generation of outputs associated with the possible states, an input signal 409 may be fed through the reference graph-based learning machine 401 and the outputs at each node of the graph-based learning machine for that input signal 409 are recorded. The recorded outputs at each node of the graph-based learning machine for that test input signal 409 may then be fed into the input signal component state importance assignment module 403, which queries the reference learning machine component state importance classification network 405 for the set of nodes in the reference learning machine that have high degrees of importance to the reference learning machine's generation of outputs for only a small number of states, along with their dominant states. The input signal component state importance assignment module 403 may then project derived products of the recorded outputs of the aforementioned set of nodes returned as query result by the reference learning machine component state importance classification module to the input signal domain, and these projected outputs may then be aggregated based on the dominant states of their associated nodes to determine the degree of importance of each component of an input signal to the reference learning machine's generation of outputs associated with the possible states.

In some other embodiments, the values of a component of an input signal 409 that has a degree of importance between a particular range are replaced by alternative values to create an altered input signal. In an illustrative embodiment, the values of a component of an input signal 409 that has a degree of importance between a lower bound lb and upper bound ub are set to zero to create an altered input signal. In another illustrative embodiment, the values of a component of an input signal that has a degree of importance between a lower bound lb and upper bound ub are set to a random value U generated by a random number generator to create an altered input signal A. It is important to note that other alternative values may be used, and the above example embodiments are not meant to be limiting. It is also important to note that the lower bound lb and upper bound ub may be set manually or determined in an automatic manner. The difference between the reference learning machine's outputs O_I associated with the possible states when the input signal 409 is fed through the reference learning machine and the reference learning machine's outputs O_A associated with the possible states when the altered signal A is fed through the reference learning machine is computed and aggregated to provide an additional metric M for the degree of importance of a component of an input signal to the reference learning machine's generation of outputs associated with the possible states.

M=J(O_I−O_A)

In an illustrative embodiment, the metric I can be defined as the squared error between O_I and O_A:

M=(O_I−O_A)\hat{ }2

In another illustrative embodiment, the metric I can be defined as the absolute error between O_I and O_A:

M=|O_I−O_A|

It is important to note that other alternative metrics may be used, and the above example embodiments are not meant to be limiting.

In some embodiments, to respond to the query for a description of why the reference learning machine generated particular outputs given an input signal, the input signal 409, the expected outputs 408, the outputs generated by the reference learning machine given the input signal, and the degree of importance of each component of an input signal to the reference learning machine's generation of outputs associated with the possible states responded by querying the explainer learning machine may be fed into the description generator module 410. The description generator module 410 may construct a description (which can be in, but not limited to, text, image, audio format or a combination of these) of why the reference learning machine generated particular outputs given an input signal 409 that may comprise of, but not limited to, some combination of: the input signal 409, the expected outputs 408, the outputs generated by the reference learning machine given the input signal, the dominant state of each component of an input signal that has a degree of importance between a lower bound lb and upper bound ub, and the location of each component of an input signal within the input signal. In an illustrative example where the reference learning machine is a neural network for determining if a car should steer left or right, where the input signal 409 is an image captured from a camera on a car, and the output is either a decision of ‘steer left’ or ‘steer right’, and expected output is either a decision of ‘steer left’ or ‘steer right’, and components of the input signal are objects (such as cars, posts, lane markings, tree, pedestrian, etc.) in the image, the description generator module 410 may construct a text description of why the reference learning machine generated particular outputs given an input signal in the following form:
“A decision of [‘steer left’/‘steer right’] was made by the machine, which a decision of [‘steer left’/‘steer right’] should be made, because there is a [‘car’/‘post’/‘lane markings’/‘tree’/ . . . ] on the [‘top left’/‘top’/‘top right’/‘left’/‘middle’/‘right’/‘bottom left’/‘bottom’/‘bottom right’] of the scene, and . . . .”

In another illustrative example where the reference learning machine is a neural network for determining if there is the concentration of chlorine is problematic or not problematic, where the input signal 409 is the chlorine levels at different pipe junctions at different times, and the output is either a decision of ‘problematic’ or ‘not problematic’, and expected output is either a decision of ‘problematic’ or ‘not problematic’, and components of the input signal are chlorine levels at different pipe junctions at different times, the description generator module 410 may construct a text description of why the reference learning machine generated particular outputs given an input signal in the following form:
“A decision of [‘problematic’/‘not problematic’] was made by the machine, which a decision of [‘problematic’/‘not problematic’] should be made, because the concentration of chlorine is [X] at pipe junction [Y] at time [T], and . . . .”

In yet another illustrative example where the reference learning machine is a neural network for determining if a stock is a ‘buy’ or a ‘sell’, where the input signal 409 is the closing stock prices at different times, and the output is either a decision of ‘buy’ or ‘sell’, and expected output is either a decision of ‘buy’ or ‘sell’, and components of the input signal are closing stock prices, open stock prices, and trade volumes at different times, the description generator module 311 may construct a text description of why the reference learning machine generated particular outputs given an input signal in the following form:
“A decision of [‘buy’/‘sell’] was made by the machine, which a decision of [‘buy’/‘sell’] should be made, because the [‘closing stock price’/‘opening stock price’/‘trade volume’] is [X1] at time [T1], and the [‘closing stock price’/‘opening stock price’/‘trade volume’] is [X2] at time [T2], and . . . .”

It is important to note that other alternative description formats may be used, and the above example embodiments are not meant to be limiting.

With reference to FIG. 4B, a high-level flowchart of process 480 of an explainer learning machine 402 is shown, in accordance with an illustrative embodiment. At Step 482, the system may receive one or more input signals 409. At Step 484, the system may pass the one or more input signals 409 to a reference learning machine 401. At Step 486, the system may feed one or more component outputs of the reference learning machine 401 to the input signal component state importance assignment module 403. In this example, at Step 488, the reference learning machine component state importance classification network 405 may receive a query, for example from an entity (including but not limited to a user or a computer), for a set of nodes in the reference learning machine 401 with high degree of importance, and with corresponding dominant states. At Step 490 the system may project derived products of the outputs of the set of nodes returned as query result by the reference learning machine component state importance classification network 405 to the input signal domain to obtain one or more projected outputs. At Step 492, the system may aggregate these projected outputs based on the dominant states of their associated nodes to determine the degree of importance of each component of an input signal 409 to the reference learning machine's generation of outputs associated with the possible states. At Step 494, the system may return, as result to the query, the degree of importance of each component of the input signals 409 to the reference learning machine's generation of outputs associated with the possible states.

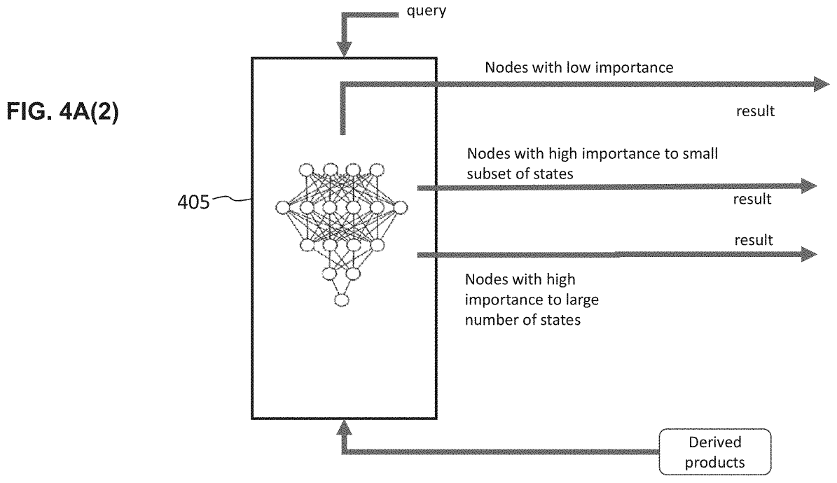

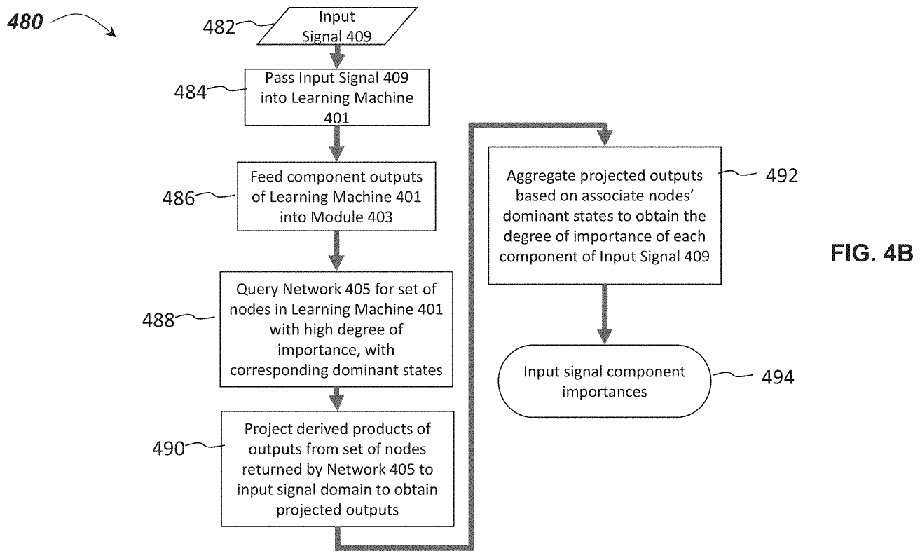

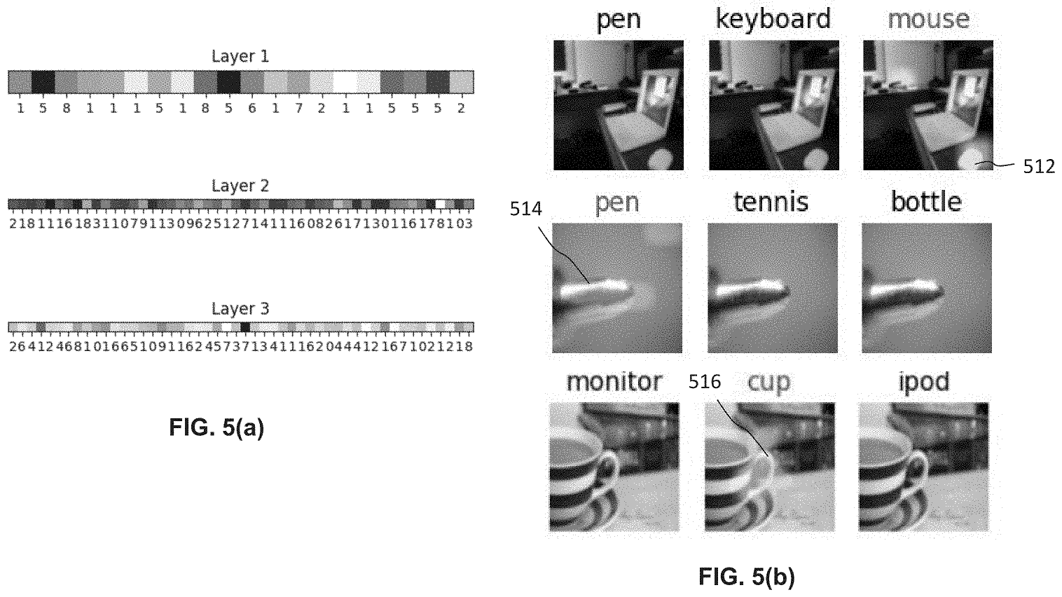

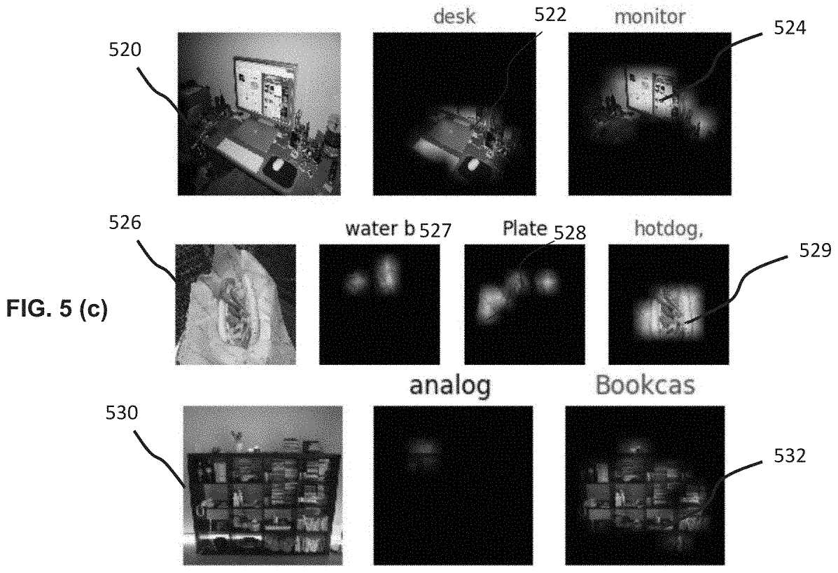

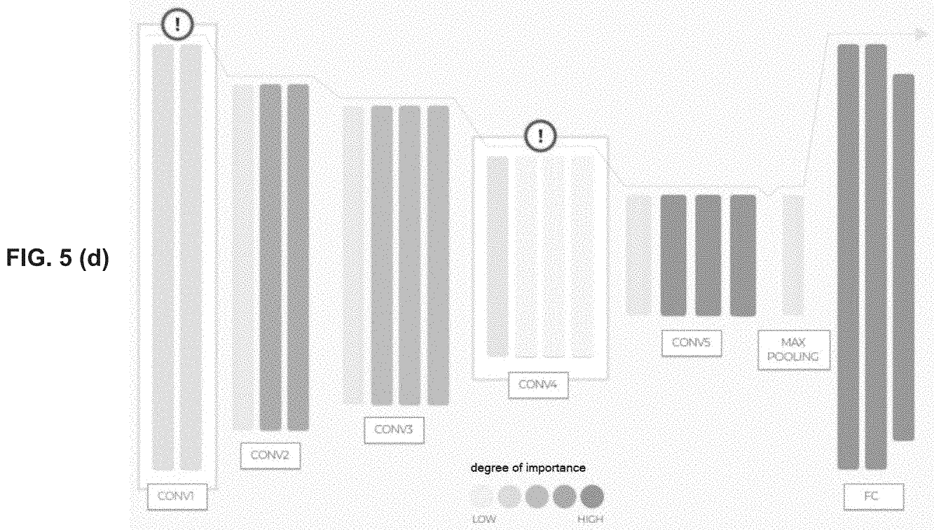

Now referring to FIGS. 5(a) to 5(e), shown are several embodiments of example visualization methods for displaying the query results from the explainer learning machine. FIG. 5(a) shows an illustrative embodiment of an example visualization of the degree of importance (shown in terms of brightness of a node, with brighter being more important) and the dominant class/state label (shown as a label number below a node) of the individual nodes at different layers of a classification neural network as determined by the explainer learning machine.

FIG. 5(b) shows an illustrative embodiment of example image input signals to a classification neural network, overlaid with a visualization of the degree of importance of the different parts of an image to each class label state in the classification neural network as determined by the explainer learning machine. For example, FIG. 5(b) shows the visualization of the degree of importance of an illuminated mouse 512 by the explainer learning machine for the class of mouse, or tip 514 for the class of pen, or handle 516 for the class of cup.

FIG. 5(c) shows an illustrative embodiment of example image input signals to a classification neural network, aggregated with a soft mask of a visualization of the degree of importance of the different parts of an image to each class label state in the classification neural network as determined by the explainer learning machine. For example, for image 512, soft mask may be used to mask parts of the image to show the degree of importance of desk 522 or monitor 524. For image 526, soft mask can be used to mask parts of the image to show the degree of importance of water bottle 527, plate 528, or hotdog 529. Similarly, soft mask may be used in image 530 to show degree of importance for bookcase 532.

FIG. 5(d) shows an illustrative embodiment of an example visualization of the degree of importance (shown in terms of brightness of a layer, with darker being more important) of individual layers of a classification neural network, as determined by the explainer learning machine, with alerts shown for layers with low degree of importance.

FIG. 5(e) shows an illustrative embodiment of an example visualization of changes in decision confidence scores of a stock price rise/fall prediction deep neural network when factors (opening price, closing price, highest price, lowest price, and trade volume) at certain dates (highlighted in red) with importance between a lower bound and upper bound are altered.

Now referring to FIGS. 6(a) to 6(h), shown are several more embodiments of example visualization methods for displaying the query results from the explainer learning machine. The illustrative embodiments of example visualizations include: FIG. 6(a) shows a histogram of the degree of importance of nodes at one of the layers of a classification neural network as determined by the explainer learning machine, FIG. 6(b) shows a degree of importance (shown in terms of brightness of a node, with brighter being more important) of the individual nodes at one of the layers of a classification neural network as determined by the explainer learning machine, FIG. 6(c) shows a scatter plot of the dominant class state distribution of nodes at one of the layers of a classification neural network as determined by the explainer learning machine, FIG. 6(d) shows components (i.e., regions of interest) of an example image input signal that has a degree of importance between a lower bound lb and upper bound ub for a classification neural network, along with the changes in decision confidence scores of a classification neural network for possible decision states (i.e., classes) when components (i.e., regions of interest) of an example image input signal that has a degree of importance between a lower bound lb and upper bound ub are altered, FIG. 6(e) shows a visualization and text description of why a car steering neural network decided to steer right given an image input signal (e.g., car 610), FIG. 6(f) shows a visualization and text description of why a transaction fraud detection neural network decided that a transaction was fraudulent given an input transaction, and FIG. 6(g) shows a visualization of why a stock price rise/fall prediction deep neural network decided that a stock will fall due to certain important factors (opening price, closing price, highest price, lowest price, and trade volume) at certain dates (highlighted in green).

FIG. 6(h) shows a visualization of the differences in what components (i.e., regions of interest) are considered important to two different classification neural networks. For example, the region 642 shows a region-of-interest that classification neural network A consider as important to its prediction that an image is of a plate, and region 640 shows a region-of-interest that classification neural network B consider as important to its prediction that an image is of a frying pan. In another example, the region 652 shows a region-of-interest that classification neural network B consider as important to its prediction that an image is of a horse, and region 650 shows a region-of-interest that both classification neural network A and classification neural network B consider as important to their respective predictions that an image is of a dog and a horse.

It is important to note that other visualization methods of displaying the query results from the explainer learning machine such as hard masking and multiple overlays of degree of importance may be used in the present system and that these embodiments should not to be considered as limiting.

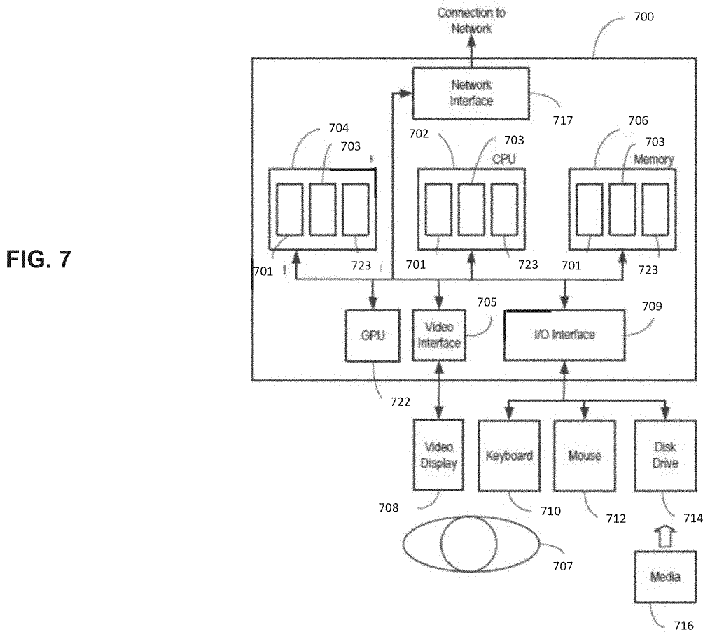

Once again, all systems described herein may utilize a computing device, such as a computing device as described with reference to FIG. 7 (please see below), to perform these computations, and to store the results in memory or storage devices, or embodied in an integrated circuit or digital signal processor.

Now referring to FIG. 7 shown is a high-level schematic block diagram of a computing device that may provide a suitable operating environment in one or more embodiments of the present disclosure. A suitably configured computer device, and associated communications networks, devices, software and firmware may provide a platform for enabling one or more embodiments as described above. By way of example, FIG. 7 shows a computer device 700 that may include one or more central processing unit (“CPU”) 702 connected to a storage unit 704 and to memory (e.g., a random access memory) 706. The CPU 702 may process an operating system 701, application program 703, and data 723. The application program 703 may include, but not limited to, reference learning machine, explainer learning machine and description generation module. The operating system 701, application program 703, and data 723 may be stored in storage unit 704 and loaded into memory 706, as may be required. Computer device 700 may further include a graphics processing unit (GPU) 722 which is operatively connected to CPU 702 and to memory 706 to offload intensive image processing calculations from CPU 702 and run these calculations in parallel with CPU 702. An operator 707 may interact with the computer device 700 using a video display 708 connected by a video interface 705, and various input/output devices such as a keyboard 710, pointer 712, and storage 714 connected by an I/O interface 709, for example, to provide input signals to the reference learning machine and queries to the explainer learning machine. In known manner, the pointer 712 may be configured to control movement of a cursor or pointer icon in the video display 708, and to operate various graphical user interface (GUI) controls appearing in the video display 708. The computer device 700 may form part of a network via a network interface 717, allowing the computer device 700 to communicate with other suitably configured data processing systems or circuits. A non-transitory medium 716 may be used to store executable code embodying one or more embodiments of the present method on the generic computing device 700.

While illustrative embodiments have been described above by way of example, it will be appreciated that various changes and modifications may be made without departing from the scope of the invention, which is defined by the following claims.

One or more of the components, processes, features, and/or functions illustrated in the figures may be rearranged and/or combined into a single component, block, feature or function or embodied in several components, steps, or functions. Additional elements, components, processes, and/or functions may also be added without departing from the disclosure. The apparatus, devices, and/or components illustrated in the Figures may be configured to perform one or more of the methods, features, or processes described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart or diagram may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system. The enablements described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

1. A computer-based method for building a learning machine to understand and explain learning machines, comprising:
receiving, by a reference learning machine, a first set of input signals;
generating, at each node of the input signals of the first set of input signals, by the reference learning machine, first outputs;
recording the first outputs generated by the reference learning machine;
updating one or more parameters in a parameter matrix based at least on one of the recorded first outputs, derived products of the recorded first outputs and corresponding expected output for each input signal of the first set of input signals; and
upon receiving a first query for a degree of importance of each node in the reference learning machine to the reference learning machine's generating of the first outputs given possible states, retrieving and returning, by a reference learning machine component state importance assignment module, a first set of parameters in the parameter matrix.

2. The computer-based method of claim 1 further comprises:
upon receiving a second query for a set of nodes in the reference learning machine that has high degrees of importance to the reference learning machine's generating of the first outputs for a small number of states, analyzing, by a reference learning machine component state importance classification module, statistical properties of a set of parameters in the parameter matrix corresponding to each node in the reference learning machine, and returning a set of nodes that have aggregated parameter values above a first classification threshold and parameter value variances below a second classification threshold.

3. The computer-based method of claim 1 further comprises:
upon receiving a third query for a set of nodes in the reference learning machine that have high degrees of importance to the reference learning machine's generating of the first outputs for a large number of states, analyzing, by a reference learning machine component state importance classification module, statistical properties of a subset of parameters in the parameter matrix corresponding to each node in the reference learning machine, and returning a set of nodes that have aggregated parameter values above a third classification threshold and parameter value variances above a fourth classification threshold.

4. The computer-based method of claim 1 further comprises:
upon receiving a fourth query for a set of nodes in the reference learning machine that have low degrees of importance to the reference learning machine's generating of the first outputs, analyzing, by a reference learning machine component state importance classification module, statistical properties of a subset of parameters in the parameter matrix corresponding to each node in the reference learning machine, and returning a set of nodes that would not be returned for a second query for a set of nodes in the reference learning machine that has high degrees of importance to the reference learning machine's generating of the first outputs for a small number of states and for the third query for a set of nodes in the reference learning machine that have high degrees of importance to the reference learning machine's generating of the first outputs for a large number of states.

5. The computer-based method of claim 1 further comprises:
upon receiving a fifth query for a degree of importance of each component of a first input signal of the first set of input signals to the reference learning machine's generating of outputs associated with the possible states:
feeding the first input signal through the reference learning machine;
generating, at each node of the first input signal, by the reference learning machine, second outputs;
recording the second outputs generated by the reference learning machine;
updating parameters in the parameter matrix;
feeding the recorded second outputs into an input signal component state importance assignment module, which queries a reference learning machine component state importance classification module for a first set of nodes in the reference learning machine that have high degrees of importance to the reference learning machine's generating of the second outputs for a small number of states, along with their dominant states;
projecting, by the input signal component state importance assignment module, derived products of the recorded second outputs of the first set of nodes; and
aggregating the projected derived products based on dominant states of their associated nodes to determine the degree of importance of each component of the first input signal to the reference learning machine's generating of the second outputs associated with possible states.

6. The computer-based method of claim 5, wherein one or more values of one or more components of one or more input signals of the first set of input signals are replaced by one or more alternative values to create an altered first set of input signals.

7. The computer-based method of claim 6, wherein the one or more values of the component of the input signal of the first set of input signals have a degree of importance between a lower bound and an upper bound.

8. The computer-based method of claim 7 further comprises generating, at each node of the input signals of the altered first set of input signals, by the reference learning machine, third outputs.

9. The computer-based method of claim 8 further comprises:
calculating and aggregating a difference between the first outputs and the third outputs; and
returning the difference as an additional metric for the degree of importance of each component of the first input signal of the first set of input signals to the reference learning machine's generating of the first outputs associated with possible states.

10. The computer-based method of claim 1 further comprises:
upon receiving a sixth query for a description of why the reference learning machine generated the first outputs given an input signal of the first set of input signals:
feeding, to a description generator module, at least one of the input signal of the first set of input signals, expected outputs for the input signal of the first set of input signals, fourth outputs generated by the reference learning machine given the input signal of the first set of input signals, and the degree of importance of each component of an input signal to the reference learning machine's generating of the first outputs associated with the possible states; and
constructing, by the description generator module, a description of why the reference learning machine generated the first outputs given an input signal of the first set of input signals.

11. A computer-based method for building a learning machine to understand and explainer learning machines, comprising:
receiving, by a reference learning machine, a first set of input signals;
generating, at each node of the input signals of the first set of input signals, by the reference learning machine, first outputs;
recording the first outputs generated by the reference learning machine; and
training a reference learning machine component state importance assignment network and the reference learning machine component state importance classification network based on derived products of the recorded first outputs along with corresponding expected output of the learning machine for each given input signal of the first set of input signals.

12. The computer-based method of claim 6 further comprises:
upon receiving a first query for a degree of importance of each node of the reference learning machine to the reference learning machine's generating of the first outputs for possible states:
feeding to the reference learning machine component state importance assignment network derived products of the recorded first outputs along with corresponding expected output of the learning machine for each given input signal of the first set of input signals; and
returning the reference learning machine component state importance assignment network output as a query result.

13. The computer-based method of claim 6 further comprises:
upon receiving a second query for a set of nodes in the reference learning machine that have high degrees of importance to the reference learning machine's generating of the first outputs for only a small number of states:
feeding to the reference learning machine component state importance classification network a degree of importance of each node in the reference learning machine to the reference learning machine's generating of the first outputs;
receiving from the learning machine component state importance classification network second outputs of which three states each node is associated with; and
returning a set of nodes classified as being nodes with high degree of importance to a small number of states as a query result.

14. The computer-based method of claim 6 further comprises:
upon receiving a third query for a set of nodes in the reference learning machine that have high degrees of importance to the reference learning machine's generating of the first outputs for a large number of states:
feeding the reference learning machine component state importance classification network a degree of importance of each node of the reference learning machine to the reference learning machine's generating of the first outputs;
receiving from the learning machine component state importance classification network second outputs of which three states each node is associated with; and
returning a set of nodes classified as being nodes with high degree of importance to a large number of states as a query result.

15. The computer-based method of claim 6 further comprises:
upon receiving a fourth query for a set of nodes in the reference learning machine that have low degrees of importance to the reference learning machine when generating of the first outputs:
feeding the reference learning machine component state importance classification network the degree of importance of each node of the reference learning machine to the reference learning machine's generating of the first outputs;
receiving from the learning machine component state importance classification network second outputs of which three states each node is associated with; and
returning a set of nodes classified as being nodes with low degree of importance as a query result.

16. The computer-based method of claim 6 further comprises:
upon receiving a fourth query for a degree of importance of each component of a first input signal of the first set of input signals to the reference learning machine's generating of the first outputs:
feeding the first input signal through the reference learning machine;
generating, at each node of the first input signal, by the reference learning machine, second outputs;
recording the second outputs generated by the reference learning machine;
feeding the second outputs into an input signal component state importance assignment module, which queries the reference learning machine component state importance classification network for a first set of nodes in the reference learning machine that have high degrees of importance to the reference learning machine's generating of the second outputs for only a small number of states, along with their dominant states;
projecting, by the input signal component state importance assignment module, derived products of the recorded second outputs of the first set of nodes; and
aggregating the projected derived products based on dominant states of their associated nodes to determine the degree of importance of each component of the first input signal to the reference learning machine's generating of the second outputs associated with possible states.

17. A system for building a learning machine to understand and explain learning machines, comprising:
a reference learning machine, wherein the reference learning machine receives a first set of input signals and generates, at each node of the input signals of the first set of input signals, first outputs;
an explainer learning machine, wherein the explainer learning machine records the first outputs generated by the reference learning machine, updates one or more parameters in a parameter matrix based at least on one of the recorded first outputs, derived products of the recorded first outputs and corresponding expected output for each input signal of the first set of input signals, and a description generator module, and responds to one or more queries for one or more quantitative insights about the reference learning machine; and
a description generator module.

18. The system of claim 17, wherein the one or more quantitative insights comprise at least one of a degree of importance of each node in the reference learning machine to the reference learning machine's generating of the first outputs given possible states, a set of nodes in the reference learning machine that has high degrees of importance to the reference learning machine's generating of the first outputs for a small number of states, a set of nodes in the reference learning machine that have high degrees of importance to the reference learning machine's generating of the first outputs for a large number of states, a set of nodes in the reference learning machine that have low degrees of importance to the reference learning machine's generating of the first outputs, a degree of importance of each component of a first input signal of the first set of input signals to the reference learning machine's generating of outputs associated with the possible states, and a description of why the reference learning machine generated the first outputs given an input signal of the first set of input signals.
